(19) United States
(12) Patent Application Publication
(10) Pub. No.: US 2010/0059175 A1
(43) Pub. Date: Mar. 11, 2010

(54) Decoration Element

(75) Inventor: Jean-Philippe Georges, Fauvillers (BE)

Correspondence Address: REINHART BOERNER VAN DEUREN P.C., 2215 PERRYGREEN WAY, ROCKFORD, IL, 61107, US

(73) Assignee: Tarkett SAS, Nanterre Cedex (FR)

(21) Appl. No.: 12/619,184

(22) Filed: Nov. 16, 2009

(30) Foreign Application Priority Data
May 25, 2007 (EP) 07010462.5

(51) Int. Cl. B44C 1/00; B32B 27/30; B32B 27/06; B32B 5/02; E04F 15/16; C08F 14/06; B44D 3/00

(52) U.S. Cl. 156/280; 428/522; 428/319.7; 442/59; 526/344; 206/1.7

(57) ABSTRACT

The present invention relates to a surface decoration kit comprising a covering for a surface to be painted, wherein said covering is PVC-based and coated with a UV-crosslinkable polyurethane polymer-based protective varnish, and a container containing a urethane-acrylic-based paint.

### OBJECT OF THE INVENTION

The present invention proposes a solution to the problem of surface decoration; a solution comprising a covering for a surface to be painted and at least a paint. The invention also relates to a painted surface covering, and a method for decorating surfaces.

### BACKGROUND OF PRIOR ART

Usually, the indoors or outdoors of a construction, a building for example, is decorated in a traditional manner by the application of paint. Generally speaking, the application of paint requires the application of a preliminary coat, called “primer”, designed to even out and matify the support, and, once this coating is dry, several coats of paint are then required to obtain a good aesthetic rendering.

Depending on the circumstances, particularly for floors, it is more pleasurable, more aesthetic, and more comfortable, to decorate a surface using a floor covering, particularly when compared to the advantages of a surface covering in relation to a bare and simply painted surface.

Among the surface coverings, and for interior decoration of a building, a dwelling or the passenger compartment of a vehicle for example, plastic coverings are commonplace. This is notably the case of PVC (polyvinyl chloride) surface coverings. Generally, these PVC surface coverings are multilayer products that comprise, on one hand, a lower layer referred to as the substrate, or support layer and, on the other hand, an upper PVC layer. The support layer can be compact, foam or textile. In the case of a foam support layer, it may concern PVC foam, for example. This support layer may or may not comprise mineral loads. The upper layer is PVC-based and has good resistance to mechanical and chemical aggressions that occur under normal conditions of use of such surface coverings. Usually, the upper PVC layer is coated with a protective varnish to reinforce abrasion wear resistance and provides the coating stain and dirt resistant properties.

Such coverings, commonly referred to as “PVC coverings”, present numerous advantages, notably in terms of comfort and flexibility, for example. Nevertheless, they also present numerous disadvantages, notably the disadvantage of being available only in certain colours, and/or of being available only in the decorative designs proposed by the manufacturer of such products. Furthermore, generally, these coverings are presented in the form of wide rolls which are not easy to handle and implement. In addition, as they concern decorated coverings with a design, it is often very difficult to position the decorative design of a roll of covering in relation to another to achieve good results. Furthermore, the presence of weld beads between rolls adversely affects the final appearance of the laid covering.

In addition, someone wanting to decorate a surface using PVC covering having the choice of the decorative design and/or the colour cannot re-decorate or modify the colour of an existing PVC covering by painting it as the paints traditionally proposed are not suitable for all coverings. Indeed, painting a PVC surface is not easy owing to the problems concerning the adhesion between the paint and the covering. Being polar and having a surface tension between 28 and 40 mN/m and low porosity, compared to traditional surface coverings, these PVC coverings are poorly suited to receive paint. In addition, generally, these PVC coverings are coated with a protective acrylic or polyurethane varnish, polyether acrylate or epoxy-acrylate for example, which provides them stain and dirt resistant properties.

One must also account for the fact that once painted, the PVC covering must have the same characteristics and the same behaviour, notably in terms of comfort, flexibility and mechanical strength as that of the unpainted covering. Furthermore, once dry, the paint must not be too rigid and must allow following the movements and deformations of the covering, failing which crazing and cracks may appear, thereby compromising the integrity of the covering. In addition, for practical reasons, the paint must have a covering effect following the application of one single coat of paint.

### Purposes of the Invention

The present invention proposes a solution for surface decoration that does not present the disadvantages of the prior art.

In particular, it aims to provide a solution for surface decoration involving the application of an easy-to-implement “do-it-yourself” decorative covering.

It also aims to provide a solution for surface decoration in which the colour and/or decorative design are not imposed.

In addition, it aims to provide a solution for surface decoration in which a single coat of paint is required in order to have sufficient opacity and mechanical strength.

It further aims to supply a method of surface decoration that does not have the disadvantages of the prior art.

### SUMMARY OF THE INVENTION

The present invention describes a surface decoration kit comprising a surface covering to be painted, said covering being PVC-based and coated with a UV-crosslinkable polyurethane polymer-based protective varnish, and containing an acrylic urethane-based paint.

The term “decoration kit” designates a set of independent elements allowing someone to decorate a given surface by themselves.

The term “surface” designates any surface, whether indoors or outdoors, vertical or horizontal. Without limitation, it may concern for example the surface of a building, a dwelling or a vehicle or simply designate the floor surface. It may also concern the surface of any body or object.

According to special embodiments, the decoration kit comprises one or more of the following characteristics:
the surface covering is a multilayer product comprising a foam or compact or textile support layer and a PVC-based upper layer.
the surface covering is in the form of tiles or at least a roll.
the decoration kit also comprises means for applying paint to the surface covering.
the decoration kit also comprises means for installing the surface covering and/or welding means of said surface covering.
the decoration kit also comprises at least a stencil and/or stencil film.
the decoration kit also comprises instructions.

The present invention also discloses a surface covering characterised in that said surface covering is a PVC-based surface covering to be painted, and coated with a UV-crosslinkable polyurethane polymer-based varnish, and in that at least an acrylic urethane-based paint is applied to said varnish.

According to a specific embodiment, the surface covering is a multilayer product comprising a foam or compact or textile support layer and a PVC-based upper layer.

The present invention further discloses a method for decorating a surface comprising the following steps:
take a PVC-based surface covering coated with a UV-crosslinkable polyurethane polymer-based protective varnish.
place said covering on a surface.
take an acrylic urethane-based paint.
apply said paint to said surface covering.

According to special embodiments, the decoration method comprises one or more of the following characteristics:
the surface covering is a multilayer product comprising a foam or compact or textile support layer and a PVC-based upper layer.
the protective varnish is obtained by UV-crosslinking of a UV-crosslinkable polyurethane polymer.
the surface covering is in the form of tiles or rolls.
the tiles or rolls are placed edge to edge on the surface to be decorated and are joined by a cold welding process.
the surface covering is decorated using acrylic urethane-based paint by using at least a stencil.

### BRIEF DESCRIPTION OF FIGURES

FIG. 1 represents a cross section of a surface covering.

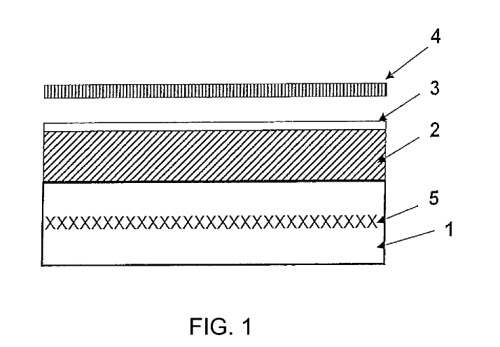

### DETAILED DESCRIPTION OF THE INVENTION

The decoration kit according to the invention has the advantage of combining the benefits of a PVC-based surface covering coated with a protective varnish, notably in terms of comfort, flexibility, sound and heat insulation and mechanical strength, with the possibility to be easily painted, by applying only one single coat of paint, with an infinite selection of colours, shades or decorative designs. In addition, once painted, the covering has the advantage of being able to resist physical aggressions and stains without requiring the application of an additional coat of varnish to the paint.

The decoration kit according to the invention is a kit in which the surface covering can be installed yourself. The kit exists, for example, in the form of small rolls, preferably 1 to 2 meters wide, or in the form of squares, or tiles, 50 cm×50 cm, or 33 cm×33 cm, easy-to-transport and easy-to-install. Preferably, the covering can be white and have a granular appearance, although it does not have decorative designs, which simplifies its installation as it can be placed edge to edge without having to respect a specific design layout.

The surface covering of the kit is preferably a multilayer product comprising a support layer, an upper layer that can be used as a wear layer, and a protective varnish.

The support layer can be a compact, foam or textile layer. Preferably, it is 0.7 mm to 5 mm thick. Advantageously, it is obtained by lamination or calendering.

Preferably, the upper layer is a PVC-based layer. Advantageously, it is 0.1 mm to 1 mm thick, but can vary according to the applications to which the multilayer covering is intended. Preferably, the upper layer is transparent.

Preferably, the PVC-based upper layer comprises plasticisers of the phthalate family, for example DIBP (Di-isobutylphthalate), DIHP (Di-isoheptylphthalate) or DINP (Di-isononylphthalate), and preferably represents between 30% and 60% by weight of the total weight of the resin.

Preferably, the support layer and/or the upper layer of the surface covering can comprise mineral loads intended to provide it with specific mechanical properties. It may concern, for example, calcium carbonate, kaolinite, talc, or a glass fibre mat.

Preferably, the support layer and/or the upper layer can contain one or more additives enabling the viscosity of the compositions used to be lowered, for example, in order to lay up the layers or to modify the mechanical properties of the final surface covering.

In a special embodiment, the decoration kit comprises a multilayer surface covering of approximately 2.83 mm thick, the foamable PVC-based support layer being 0.432 mm thick, the PVC upper layer being 0.120 mm thick and the protective varnish being 0.008 mm thick.

The paint, to be applied to the surface covering to be painted, must also adhere to the covering, have sufficient wettability, and uniform appearance, as soon as the first coat is applied, and it must be sufficiently elastic in order to be able to follow the deformation of the covering on which it is applied.

The uniform appearance or the opacity is deemed sufficient if it is not possible to distinguish the initial colour or the surface covered by the paint, and if the visual appearance and colour of the painted surface are homogenous.

Various wall and floor paints exist in different colours (Table 1), such as, for example, acrylic, urethane alkyd, polyurethane-alkyd, or even urethane acrylic paints, but among all these paints, all are not suitable to decorate PVC-based surface covering. After the application of a single coat of paint, the opacity of some of these paints does not sufficiently satisfy the convenience criteria of a decoration kit.

TABLE 1
Paints tested.

| | | | One coat |
|---|---|---|---|
| | Paint | Type of binder | opacity |
| 1 | Polyfilla | Alkyd | Insufficient |
| | Hammerite rouge | | |
| | (satin-finish | | |
| | lacquer) | | |
| 2 | Polyfilla | Styrene-alkyd | Good |
| | Hammerite garage | | |
| | bleu (lacquer) | | |
| 3 | Gérard Secolux | PU-alkyd | Good |
| | Email Lilas bleu | | |
| | satin | | |
| 4 | Gérard Geralac | Acrylic | Insufficient |
| | Email Lack | | |
| | Brillant 6005 | | |
| | vert | | |
| 5 | Opus 1 | Acrylic | Insufficient |
| | Wohnraumwiess | | |
| | (wall) | | |
| 6 | Zero PUR-Lack HP | Two-component | Good |
| | (2 components) | Acrylate/ | |
| | (floor) | isocyanate | |
| 7 | Caparol Indeko | Acrylic | Good |
| | Plus Lapis 13 | | |
| | (wall) | | |
| 8 | Caparol PU-Alkyd | PU-alkyd | Good |
| | Satin Agave 145 | | |
| | wall) | | |
| 9 | Caparol | Alkyd | Good |
| | Hochglanz- | | |
| | Buntlack Verona | | |
| | 140 | | |
| 10 | Caparol Capacryl | PU-acrylic | Insufficient |
| | PU Vorlack Cameo | | |
| | 180 (wall) | | |
| 11 | Caparol Vorlack | Alkyd | Good |
| | Patina 105 | | |
| | (wall) | | |
| 12 | Levis Laque | Alkydurethane | Good |
| | Satin vert | | |
| | empire 5834 | | |
| | (wall) | | |
| 13 | Levis Levilux | Alkyd | Good |
| | Gris perle | | |
| 14 | Levis Floor | Urethane- | Good |
| | Regular vert | acrylic | |
| | tendre 5516 | | |
| | (floor) | | |
| 15 | Caporal | Polyvinyl | Insufficient |
| | Capatrend Marill | acetate | |
| | 125 (wall) | | |
| 16 | Caporal | Polyvinyl | Insufficient |
| | Capatrend | acetate | |
| | Bordeaux 65 | | |
| | (wall) | | |
| 17 | Caporal Capacryl | PU-acrylic | Insufficient |
| | PU Vorlack | | |
| | Saphirblau | | |
| | (wall) | | |

It is generally admitted that it is very difficult to apply paint to an acrylic or polyurethane-based upper layer of protection (or protective varnish) for example, as it is a layer to which very few things adhere. This is why the adhesion of the various paints to the upper layer of a PVC-based surface covering, without protective varnish, was tested. As shown in Table 2, polyurethane-alkyd, acrylic or urethane-acrylic paints adhere to the PVC-based upper layer. This is the case for paints No. 4, No. 9, No. 10, and No. 14; nevertheless, paints No. 4 and No. 10 are not adequate as they have mediocre coverage after application of one single coat and have insufficient wettability.

Despite the preconceived idea that it is difficult to apply paint to acrylic or polyurethane-based protective varnish, different paints were tested to determine which paints offered good adhesion for these varnishes.

TABLE 2
Adhesion of the various paints tested

| | | Adhesion with |
|---|---|---|
| Upper layer | Type | paints |
| None | | 4, 9, 10, 14 |
| Gérard Geralac white | Acrylic | 1, 4, 8, 10 |
| primer | | |
| Gérard Primodur LM | Acrylic | None |
| Caparol Haft Primer | Acrylic | 4, 8, 10 |
| Satin Saphir 120 | | |
| Tarkett Anti 5-58 | Acrylic | 1, 4, 6, 7, 8, 10, |
| | | 16 |
| Tarkett PUTR | UV-crosslinkable | 6, 14 |
| | polyurethane | |

As shown in Table 2, apart from the Gerard Primodur acrylic varnish to which none of the paints tested adhere, the various varnishes allow the different paints to adhere to the covering. However, among these paints, only the paints No. 6, No. 7, No. 8, and No. 14 present a sufficiently uniform appearance following a single application.

PVC coverings, comprising the various painted varnishes, were evaluated to determine which varnish/paint combinations provided the painted PVC covering with the best dirt resistant and resistance to traffic properties.

The dirt resistance test consists in placing roughly ten or so representative stains on a sample of covering and determining how easy it is to clean them using a dry rag, or a rag moistened with water or alcohol.

The resistance to traffic test consists in covering the floor of an area having intense traffic (average industrial type) with a sample of painted covering, measuring 50 cm×50 cm for example, and then to record the visual appearance of the paint, its dirtiness, its tackiness, and its cleanability after a certain time. The visual appearance of the paint is judged by its level of coverage, its dirtiness by the number of stains present, and its tackiness by a dustiness test followed by cleaning with water.

Subjected to intense traffic, it surprisingly appeared that all the coverings, including a painted varnish, do not resist mechanical aggressions and stains in the same manner over time. In particular, coverings coated with a painted acrylic varnish have a lower resistance to stains and dirt than coverings coated with a painted PUTR varnish. The coverings coated with an acrylic varnish rapidly become dirty, the paint becomes tacky, and cleaning becomes difficult.

Only the combinations of PUTR/paint No. 6 and PUTR/paint No. 14 exhibit greater resistance over time. Paint No. 14 is a two-component paint that is not easy to implement and has the disadvantage of being potentially toxic when handled. Thus, only paint No. 6, a urethane-acrylic paint, is suitable for painting a PVC covering coated with a UV-crosslinkable polyurethane protective varnish, as it has the advantage of adhering to the varnish while exhibiting elasticity allowing it to deform with the covering, and it allows the covering to maintain its resistance to wear and grime over time. In particular, in a puncture test, it appears that the paint does not degrade the performance characteristics of the covering; indeed, the puncture resistance of a PVC covering, whose polyurethane varnish is painted, is 82±5 N while it is 79+5 N for this same covering whose polyurethane varnish is not painted (Table 3).

TABLE 3
Puncture resistance

| | | Average/Standard |
|---|---|---|
| PVC covering | Values in Newton | deviation |
| Protective | 89.5; 81.8; 82.3; 79.9; | 82 ± 5 N |
| varnish with | 82.6; 79.6; 72.6; 87.3; | |
| paint | 86.3; 81.2 | |
| Protective | 79.0; 74.3; 82.6; 73.7; | 79 + 5 N |
| varnish without | 81.4; 77.1; 85.9; 75.7; | |
| paint | 85.1; 75.0 | |

This improved resistance to traffic obtained through the use of a PUTR varnish appears to be attributable to the fact that this polyurethane varnish prevents the plasticisers of the upper layer, whose function it is to soften it, to rise to the surface and enter the paint. In a covering coated with a painted acrylic varnish, the plasticisers pass through the acrylic varnish, enter the coat of paint, downgrading and altering not only the properties of the paint, but also those of the covering. The paint, which is rendered tacky by the plasticisers, traps the dust and dirt, which renders the covering more sensitive to grime.

Preferably, prior to its application on the upper layer of the covering, the UV-crosslinkable polyurethane composition, forming the protective varnish, is in the form of an aqueous emulsion. This composition is applied on the upper layer by all suitable means, preferably by coating or surface application. Once the polyurethane composition is applied, the protective varnish is formed by crosslinking of the polyurethane composition. This crosslinking is achieved by subjecting the composition to UV rays for 10 to 30 seconds, for example, an UV oven having a power of 900 mjoules/cm², for example.

For a polycarbonate and acrylic-based polyurethane protective varnish (in a 1:1 proportion), thermally crosslinked, for example at 160° C. by contact with a heating drum, the paints No. 6 and No. 14, which offer the best adhesion on the UV-crosslinkable polyurethane-based varnish, exhibit poor adhesion to the thermally crosslinked polyurethane varnish.

In a special embodiment, the varnish is applied to the upper layer once the covering is placed on the surface to be decorated. Nevertheless, in another special embodiment, the varnish is applied to the upper layer during the manufacture of the surface covering, which saves time for the user of the decoration kit according to the invention.

Preferably, the decoration kit according to the invention comprises at least a recipient containing a urethane-acrylic paint. Preferably, the kit contains several recipients containing paint of various colours in order to provide the greatest possible choice. The user of the kit can use a single paint of a single shade or mix the various colours provided in the kit.

The urethane-acrylic paint is applied by all appropriate means, although preferably by brush or aerosol.

Preferably, the decoration kit according to the invention comprises means to apply the paint in the kit; advantageously, the kit includes at least a brush.

Preferably, the decoration kit according to the invention comprises means for installing the covering and/or cold welding means.

Preferably, the covering installation means comprise means for cutting the covering, and means to secure the covering to the floor.

Advantageously, the means for cutting the covering include a knife or a cutter.

Advantageously, the means to secure the covering to the floor comprise an adhesive, glue, or a primer.

The installation of a surface covering in the form of rolls or tiles requires that such elements be placed edge to edge and performing a weld between the rolls or tiles to ensure an aesthetic finish. This weld is performed in a conventional manner by all appropriate means. Preferably, a cold welding technique is used.

Preferably, the cold welding means comprise a recipient containing a solvent for joining the joints, smooth masking paper, and a revolving-wheel cutter for cutting the masking paper.

Preferably, the solvent used to weld the strips or tiles of PVC covering is THF (tetrahydrofuran).

Preferably, the decoration kit according to the invention also comprises at least a stencil allowing the user of the kit to decorate the surface covering with diverse and varied designs. Advantageously, the kit comprises a stencil film, for example made of transparent PVC or crystal acetate, in order to allow the user of the kit to reproduce the designs chosen.

### KEY

1: support layer
2: upper layer
3: protective varnish
4: coat of paint
5: glass fibre mat

1. A surface decoration kit comprising a surface covering to be painted, said covering being PVC-based and coated with a UV-crosslinkable polyurethane polymer-based protective varnish (3), and a recipient containing an acrylic urethane-based paint.

2. The decoration kit according to claim 1 in which the surface covering is a multilayer product comprising a foam or compact or textile support layer (1) and a PVC-based upper layer (2).

3. The decoration kit according to claim 1 in which the surface covering is in the form of tiles or at least a roll.

4. The decoration kit according to claim 1 also comprising means to apply the paint to the surface covering.

5. The decoration kit according to claim 1 also comprising means for installing the surface covering and/or welding means of said surface covering.

6. The decoration kit according to claim 1 also comprising at least a stencil and/or a stencil film.

7. The decoration kit according to claim 1 also comprising instructions.

8. A surface covering characterised in that said surface covering is a PVC-based covering to be painted and coated with a UV-crosslinkable polyurethane polymer-based varnish (3) and in that at least an acrylic urethane-based paint is applied to said varnish (3).

9. The surface covering according to claim 8 in which the surface covering is a multilayer product comprising a foam or compact or textile support layer (1) and a PVC-based upper layer (2).

10. A method for decorating a surface comprising the following steps:
take a PVC-based surface covering coated with a UV-crosslinkable polyurethane polymer-based protective varnish (3).
place said covering on a surface.
take an acrylic urethane-based paint.
apply said paint to said surface covering.

11. The method of decoration according to claim 10 in which said surface covering is a multilayer product comprising a foam or compact or textile support layer (1) and a PVC-based upper layer (2).

12. The method according to claim 10 in which the protection varnish is obtained by UV-crosslinking of a UV-crosslinkable polyurethane polymer.

13. The method according to claim 10 in which the surface covering is in the form of tiles or rolls.

14. The method according to claim 10 in which the tiles or rolls are placed edge to edge on the surface to be decorated and are joined by a cold welding process.

15. The method according to claim 10 in which the surface covering is decorated using an acrylic urethane-based paint and by using at least a stencil.
